(19) United States
(12) Patent Application Publication
(10) Pub. No.: US 2019/0171004 A1
(43) Pub. Date: Jun. 6, 2019

(54) DEVICE FOR PROTECTING AN OPTICAL SENSOR AND DRIVER ASSISTANCE SYSTEM COMPRISING AN OPTICAL SENSOR

(71) Applicant: Valeo Systèmes d'Essuyage, Le Mesnil Saint Denis (FR)

(72) Inventors: Frédéric Bretagnol, Issoire (FR); Marcel Trebouet, Le Mesnil Saint Denis (FR)

(73) Assignee: Valeo Systèmes d'Essuyage, Le Mesnil Saint Denis (FR)

(21) Appl. No.: 16/321,241

(22) PCT Filed: Jun. 9, 2017
(86) PCT No.: PCT/EP2017/064159

§ 371 Date: Jan. 28, 2019

(30) Foreign Application Priority Data
Jul. 28, 2016 (FR) 1657326

(51) Int. Cl. G02B 27/00; H04N 5/217; G02B 1/10; H04N 5/225

(52) U.S. Cl. CPC G02B 27/0006; H04N 5/2252; G02B 1/10; H04N 5/2171

(57) ABSTRACT

The invention concerns a driver assistance system (1) comprising a device (2) for protecting an optical sensor (11) for a motor vehicle comprising a protective box (13) in which a housing (26) is provided that is configured to house an optical sensor (11), the device further comprising: a support (15) movably mounted on the protective box (13) and bearing a membrane (19) attached by its periphery to the support (15) and intended to be arranged opposite the optical sensor (11), the membrane (19) comprising an optically transparent material that is elastically deformable; and at least one actuator (21) borne by the protective box (13) and configured to move the support (15) bearing the membrane. The support (15), under the effect of the moving of the support (15) by the actuator (21), is configured to deform the membrane (19) between a resting position in which the membrane (19) is in a first state of tension and an active position in which the membrane (19) is in a second state of tension.

The present invention relates to the driving aid field and in particular to the driving assistance systems that are installed on certain vehicles, the assistance system being able to include an optical sensor such as, for example, a camera comprising a lens. More particularly, the invention relates to a protection device of such a driving assistance system comprising means for cleaning the optic thereof.

Currently, front, rear or even side vision cameras equip a large number of motor vehicles. They form in particular part of the driving assistance systems, such as parking aid systems, or even lane departure detection systems.

There are cameras installed inside the interior of a motor vehicle as an aid to parking. These cameras are well protected from random climatic factors such as smears linked to organic or mineral pollutants. However, the viewing angle for such cameras, installed inside the interior, is not optimal, particularly for aid to parking because they do not make it possible to see the obstacles located in proximity to the rear of the vehicle for example.

Preference is therefore given to installing these driving assistance systems, and in particular their cameras, on the outside of the vehicles at different points depending on the desired use. In such a case, the driving assistance system, and in particular the camera of such a system, is therefore greatly exposed to random climatic factors and to smear sprays which can reduce its effectiveness, even render it inoperative.

To counter the deposition of smears on the driving assistance system, it is known practice to arrange a device for cleaning the optic of the camera, generally a cleaning liquid spray nozzle in proximity thereto in order to eliminate the pollutant elements which are deposited over time.

Also, the optic of the camera, generally formed by a lens, is a relatively fragile device. It is therefore necessary to protect it from spray which could damage it. It is therefore commonplace to find such cameras housed inside protection casings comprising a protection window arranged facing the lens. However, the cleaning of the lens or of the window of the casing protecting the latter is an important criterion in ensuring the optimal operation of the camera.

The document US2014/0036084 discloses a camera mounting inside a protection casing in which there is a piezoelectric vibrator which makes it possible to vaporize water droplets present on the lens of the camera and thus clean them when the vehicle is running.

However, such a system does not make it possible to clean the organic or mineral smears, or even traces of water filled with various pollutants which would have been deposited on the lens and would have had time to dry because, for example, of the prolonged parking of the vehicle.

Also known from the document US2012/0243093 is a casing comprising a camera and equipped with a piezoelectric device and a cover protecting the lens of the camera. The piezoelectric device makes it possible to vibrate the assembly composed of the casing and the camera, and thus prevent organic or mineral smears from adhering to a cover protecting the lens.

However, such vibration of the assembly greatly increases the risks of breaks and/or cracks of the material forming the lens or the cover covering the latter so as to close a casing in which the optical sensor is arranged. To form the lens, it is therefore necessary to use glasses or plastics that are highly resistant to vibrations and impacts which are generally costly. Also, such vibrations can damage the internal system of the camera, in particular its electronic components.

In order to be able to clean the lenses of cameras having organic or mineral smears, without risking damaging the lens or the optical sensor, the document FR2841488 discloses a casing enclosing a camera with means for cleaning the casing composed of a spray nozzle and means for vibrating the window facing the camera. This casing also comprises de-icing and demisting means. Furthermore, to limit the traces of water, this window is produced in a hydrophobic material which has undergone a catalytic treatment in order to reduce the adherence of water and of the organic pollutants thereon.

However, this device can in some cases be too bulky, particularly when it is intended to be installed at the level of the registration plate of the vehicle, on the front or rear bumpers, or even on the rearview mirrors. Moreover, this device allows only the runoff of the cleaning liquid over the glass, its effectiveness for tenacious and embedded smears can be limited despite the vibration of the glass and the catalytic treatment that the latter has undergone. Also, the presence of a spray nozzle requires cleaning liquid intake ducts to be formed on the casing. These ducts must generally be formed by the manufacturer and require a more complex initial design within the vehicle.

The present invention sets out to at least partially remedy the drawbacks of the prior art mentioned above by presenting a protection device protecting an optical sensor which ensures a good protection thereof and in which the cleaning of the optic is rapid, efficient, and without necessarily requiring a cleaning liquid, both for the traces of water and for organic or mineral smears which would have had the time to adhere strongly to the optic of the optical sensor included in the driving assistance system.

To this end, the subject of the invention is a protection device protecting an optical sensor for a motor vehicle comprising a protection casing in which is formed a housing configured to house an optical sensor, characterized in that said device also comprises:
a support movably mounted on the protection casing and bearing a membrane fixed by its periphery to the support and intended to be arranged facing the optical sensor, the membrane comprising an optically transparent and elastically deformable material; and
at least one actuator borne by the protection casing and configured to move the support bearing the membrane;
   and in that the support, under the effect of the moving of the support by the actuator, is configured to deform the membrane between a position of rest in which the membrane is in a first state of tension and at least one active position in which the membrane is in a second state of tension. In the second state of tension the membrane is more taut than in the first state of tension.

Thus, if the smears come to be deposited on the membrane situated in front of the optical sensor housed in the protection casing, the mobile support bearing the membrane will be able to allow the elastic deformation of the latter upon the movement of said support.

When the membrane is in its second state of tension, the smears will be able to drop from the membrane because the surface of contact of the smears on the membrane is reduced. The membrane exhibits a greater elasticity than the smears which adhere to the membrane. Because of this, the adhesion links between the smears and the membrane will be broken when the membrane is in its second state of tension and thus allow the smears to drop.

The device for protecting the optical sensor according to the invention can also comprise one or more of the following features taken alone or in combination:

The optically transparent and elastically deformable material of the membrane is an elastomer.

The protection casing has a substantially central opening allowing the passage of an optic of the optical sensor and at least one first guiding member configured to cooperate with a complementary second guiding member borne by the support.

The support comprises a plate secured to at least one second guiding member and comprising an opening in which the membrane is placed, the plate being intended to be oriented substantially at right angles to the optical axis of the optical sensor.

The support comprises a fixing ring for the membrane surrounding the opening in which the membrane is placed.

The complementary guiding members are oriented so as to allow a translational movement of the support along an axis substantially at right angles to the plate of the support.

The opening of the plate is configured to accommodate the optic in such a way that it protrudes from the opening and is in contact with the elastic membrane.

The complementary guiding members are formed by a rod/cylinder system.

The actuator of the support comprises at least one of the elements chosen from the following list: a piezoelectric transducer, an electromagnet, a mechanical system comprising a toothed wheel and a rack.

According to a variant, the actuator is arranged inside the protection casing.

According to another variant, the actuator is arranged outside the protection casing.

The actuator is configured to move the support at a frequency lying within the ultrasound range.

The formulation of the elastomer forming the membrane exhibits properties of resistance to ultraviolet radiations and/or non-stick properties.

Another subject of the invention is a driving assistance system comprising an optical sensor and comprising a protection device as described previously.

Thus, the driving assistance system can be directly installed on any kind of vehicle. The optical sensor comprises at least one camera which will thus be protected from external abuses, thus avoiding having the field of view of the camera being altered by traces of water or by the smears linked to organic or mineral pollutants. The optical sensor will therefore have optimized operation.

The driving assistance system can also comprise one or more of the following features taken alone or in combination:

The actuator is configured to move the support along the optical axis of the optical sensor.

The optic of the optical sensor protrudes through an opening of the plate of the support and is in contact with the elastic membrane arranged on the plate.

Other advantages and features will become apparent on reading the description of the invention, and from the attached drawings in which:

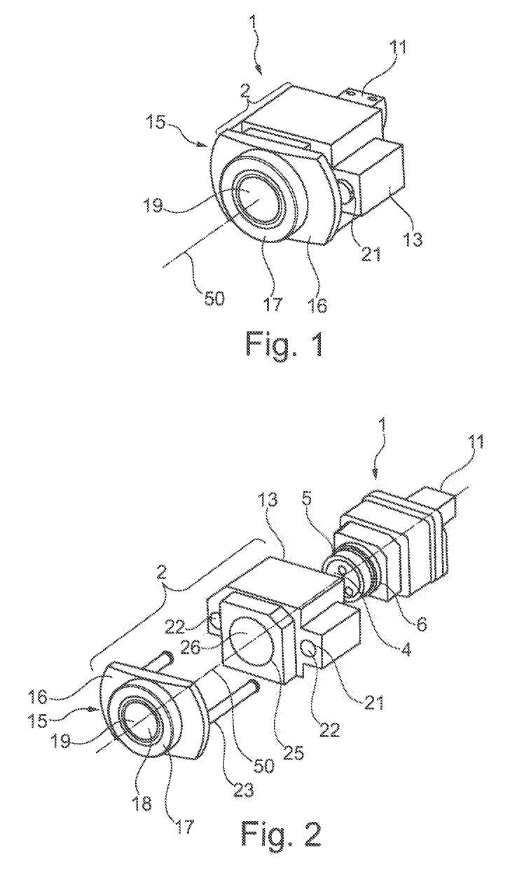

FIG. 1 is a schematic view of the driving assistance system according to the invention,

FIG. 2 is an exploded view of the driving assistance system of FIG. 1,

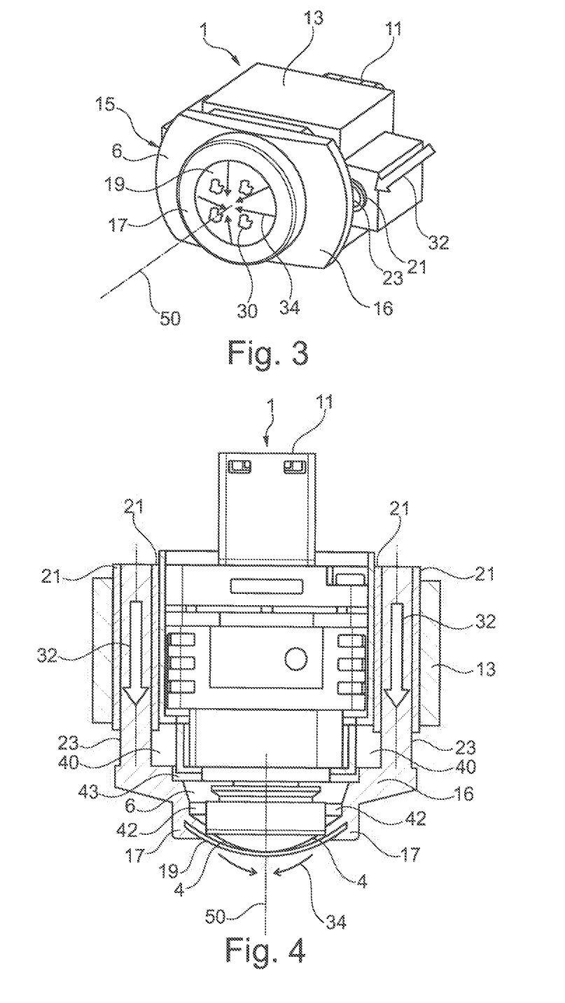

FIG. 3 is a schematic view of the driving assistance system when the membrane is in a position of rest,

FIG. 4 is a longitudinal cross-sectional view of the driving assistance system when the membrane is in position of rest,

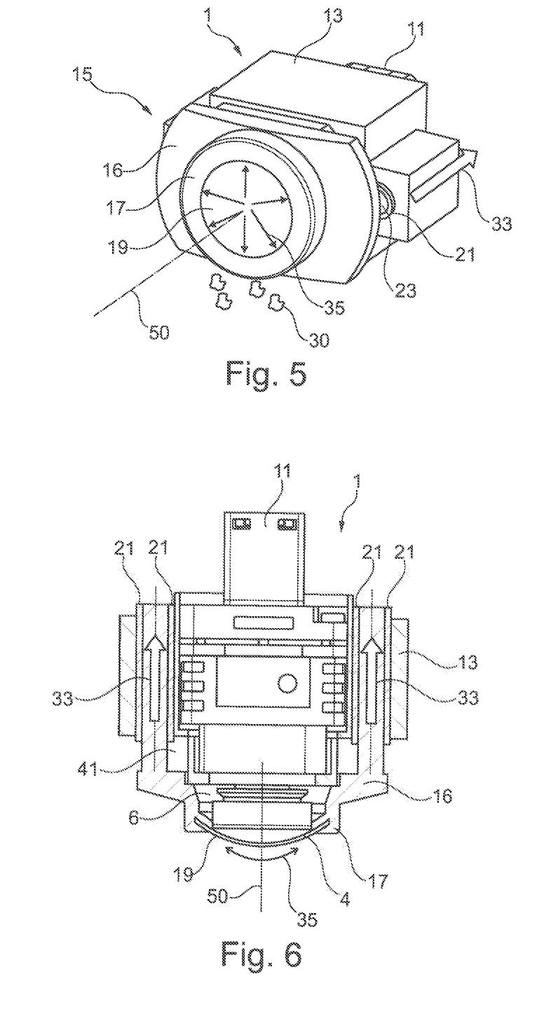

FIG. 5 is a schematic view of the driving assistance system when the membrane is in an active position,

FIG. 6 is a longitudinal cross-sectional view of the driving assistance system when the membrane is in active position.

In these figures, the elements that are the same bear the same numeric references.

The following embodiments are examples. Although the description refers to one or more embodiments, this does not necessarily mean that each reference relates to the same embodiment, or that the features apply only to a single embodiment. Single features of different embodiments can also be combined or interchanged to provide other embodiments.

In the following description, reference is made to first guiding members and to second guiding members. This relates to a simple indexing for differentiating and naming elements that are similar but not identical. This indexing does not imply a priority of one element over another and such denominations can easily be interchanged without departing from the scope of the present invention. Nor does this indexing imply an order in time, for example for assessing the movement of the support.

Referring to FIGS. 1 and 2, the invention relates to a driving assistance system 1 comprising an optical sensor 11 for a motor vehicle and a protection device 2 protecting the optical sensor 11.

The protection device 2 comprises, on the one hand, a protection casing 13 in which is formed a housing 26 configured to house the optical sensor 11, such as a camera, and, on the other hand, a membrane support 15 movably mounted on the protection casing 13.

The protection casing 13 has a substantially central opening 25 configured to allow the passage of an optic 4 of the optical sensor 11. Furthermore, the protection casing 13 bears at least one first guiding member 22 configured with a complementary second guiding member 23 borne by the support 15.

According to the embodiment described here, the protection casing 13 comprises two guiding members 22 of cylinder type and the second guiding members 23 borne by the support 15 are of rod type.

The protection casing 13 also comprises at least one actuator 21 configured to move the support 15 along the optical axis 50 of the optical sensor 11. According to the embodiment described here, the protection casing comprises two actuators 21 situated on either side of the substantially central opening 25 of the protection casing 13. These actuators 21 are situated inside the guiding members 22 of cylinder type to enter into contact with the second guiding members 23.

Moreover, according to this nonlimiting exemplary embodiment, the actuators 21 are linear piezoelectric transducers. Thus, the actuator 21 has a small bulk and is protected from external abuses which can be linked to random climatic factors or even to organic or mineral pollutants, which could prevent it from operating correctly.

The support 15 bears the membrane 19 which is fixed by its periphery thereto. According to the embodiment described here, the support 15 comprises a plate 16 secured to the second guiding members 23. To this plate 16 there is fixed a fixing ring 17 for the membrane 19 and in which is an elastically deformable membrane 19 intended to be arranged facing the optical sensor 11,

The plate 16 is intended to be oriented substantially at right angles to the optical axis 50 of the optical sensor 11 and comprises an opening 18 configured to accommodate the optic 4 of the optical sensor 11 in such a way that it protrudes from the opening and is in contact with the membrane 19. The substantially central opening 25 of the protection casing 13 and the opening 18 of the plate 16 of the support 15 are therefore centered relative to the optical axis 50 of the optical sensor 11 and concentric.

The support 15, under the effect of its movement by the actuator 21, is configured to be displaced between a position of rest in which the membrane 19 is in a first state of tension (represented in FIGS. 3 and 4), and an active position in which the membrane 19 is in a second state of tension (represented in FIGS. 5 and 6). In the second state of tension, the membrane 19 is more taut than in the first state of tension.

The membrane 19 is elastically deformable and comprises an optically transparent material. The use of an elastomer in the formulation of the membrane 19 allows the latter to exhibit the elastic deformation sought. According to the embodiment described here, the membrane 19 is an elastomer exhibiting properties of resistance to ultraviolet radiation and non-stick properties. Because of its potential installation on the outside of a motor vehicle, it is advantageous for the properties of the membrane 19, in particular of elasticity and of transparency, not to be altered by ultraviolet radiations. For example, it is best to avoid it becoming tarnished or opaque, or even it becoming embrittled because of exposure to the sun, in particular because of the UV radiation, that it will intrinsically be subjected to in its use.

According to this particular embodiment, silicon is introduced into the formulation of the elastomer. That makes it possible to confer on the elastomer a good resistance to ultraviolet radiations. The use of silicon in the formulation of the elastomer forming the membrane 19 also makes it possible to confer a hydrophobic character thereon. Drops of water will therefore be able to adhere to the membrane 19 only with difficulty and the traces that they would allow through their runoff would be almost invisible. Also, to limit the possibilities of adherence of the traces of water or of pollutants, the membrane 19, preferably, has non-stick properties. Furthermore, according to this embodiment, the membrane 19 is fixed in the ring 17 by its periphery.

The complementary guiding members 22 and 23 are oriented so as to allow a translational movement of the support 15 along an axis substantially at right angles to the plane defined by the plate 16 and more particularly along the optical axis 50 of the optical sensor 11.

Referring to FIGS. 3 and 4, the membrane 19 is in a position of rest, that is to say that it is in a first state of tension.

The arrows 32 directed toward the center illustrate the movement of the guiding members 23 under the effect of the actuator 21 when the support 15 is displaced in order for the membrane 19 to reach its position of rest. “Movement of the guiding members 23” should be understood to mean the displacement of the mobile support 15 relative to the protection casing 13.

The arrows 34 show the direction of deformation of the membrane 19 in response to the moving of the support 15. According to this representation, the direction of deformation of the membrane 19 is toward the interior thereof. This deformation of the membrane 19 occurs in response to the displacement of the support 15. In this position of rest, the membrane 19 is in its first state of tension. In this position, the smears 30, such as organic or mineral pollutants as well as traces of water, can be deposited on the membrane 19 and thus be detrimental to the correct operability of the driving assistance system 1.

According to FIG. 4, the actuator 21 is configured to move the support 15 along the optical axis 50 of the optical sensor 11. This type of translation avows the membrane 19 to undergo similar pulling forces over all of its surface when it switches to active position.

The movement of the support 15 is possible by virtue of gaps 40, 42 and 43 present between the support 15 and the protection casing 13. These gaps 40, 42 and 43 each define a spacing between the support 15 and the protection casing 13 which is maximal (FIG. 4) when the membrane 19 is in position of rest and minimal (FIG. 6) when the membrane 19 is in its active position.

According to the representation in FIG. 4, the gap 40 corresponds to the space present between the protection casing 13 and the support 15 at the level of the guiding members 22. The gap 42 corresponds to the space between the ring 17 and the rim of the objective 6 bearing the lens 4 of the camera 11. The gap 43, for its part, corresponds to the space between the support 15 and the surface of the protection casing 13 having the substantially central opening 25 intended to accommodate the lens 4 of the camera 11. According to this embodiment, it will be noted that the lens 4 protrudes through the opening 18 of the plate of the support 15. According to this representation, it will be observed that the lens 4 is partially in contact with the membrane 19 arranged on the plate 16 when the membrane 19 is in position of rest. It will also be noted, according to this representation, that the elastic membrane 19 is arranged coaxially with the optical axis 50 of the optical sensor 11.

The contact between the membrane 19 and the lens 4 of the camera 11 will make it possible to tension the membrane 19 when the latter switches from its position of rest, that is to say its first state of tension, to its active position, that is to say its second state of tension, under the effect of the moving of the support 15. For this change of position to be possible, it is necessary for the membrane 19 to be facing the lens 4 of the optical sensor 11.

FIGS. 5 and 6 represent the membrane 19 in its active position, that is to say that it is in the second state of tension. When the membrane 19 is in this second state of tension, it is more taut than when it is in its first state of tension.

The arrows 33 directed outward from the center illustrate the movement of the guiding members 23 under the effect of the actuator 21 when the support 15 is displaced in order for the membrane 19 to reach its active position. These arrows 33 are opposed to the arrows 32 represented in FIGS. 3 and 4.

The arrows 35 illustrate the direction of deformation of the membrane 19. According to this representation, the deformation of the membrane 19 corresponds to an extension thereof when the membrane 19 switches to its second state of tension. This deformation therefore takes place toward the outside of the membrane 19. These arrows 35 are opposed to the arrows 34 represented in FIGS. 3 and 4. This tension will allow the smears 30 to drop from the surface of the membrane 19.

According to FIG. 6, the gap 41 between the support 15 and the protection casing 13 corresponds to the minimum possible space between these two elements. This gap 41 corresponds to the gap 40 represented in FIG. 4 when the membrane 19 is in its position of rest. It will be noted that the gaps 42 and 43 initially present in FIG. 4 between the support 15 and the base of the objective 6 of the optical sensor 11 have disappeared because of the moving of the support 15 relative to the protection casing 13 under the effect of the actuator 21.

In this active position, the elastic membrane 19 is, according to this embodiment, fully in contact with the lens 4 of the optical sensor 11 which protrudes through the opening of the plate 16 of the support 15 which bears the ring 17. The contact between the membrane 19 and the lens 4 will serve as bearing point. Moreover, since the membrane 19 is fixedly mounted in the ring 17 borne by the support 15, the membrane 19 will be able to stretch to reach its active position when the support 15 approaches the protection casing 13 or to shrink to reach its position of rest when the support 15 moves away from the protection casing 13. Thus, the membrane 19 will tighten and switch to active position when the support 15 approaches the protection casing 13 under the effect of the actuator 21.

During the operation of the protection device 2 according to the invention, the support 15 will perform several reciprocal movements at a predefined frequency. According to this embodiment, the frequency of displacement of the support 15 relative to the protection casing 13 lies within the ultrasound range.

When the membrane 19 is in active position, the contact surface between the membrane 19 and the smears 30 is reduced. Thus, links between the smears 30 and the membrane 19 will be broken thus allowing the latter to drop. Also, the membrane 19 exhibits a greater elasticity than the smears 30 which adhere thereto. Because of this, by stretching the membrane 19, there is also a tendency to stretch the smears 30, which is not possible because of their lesser elasticity. These two combined actions linked to the tension of the membrane 19 will allow the smears to drop therefrom. Moreover, when the membrane 19 is in its second IS state of tension, the latter will allow links to be broken within the smears 30 and thus facilitate the disintegration thereof.

According to this particular embodiment, by using piezoelectric transducers as actuator 21, a deformation of the membrane 19 lying between 0.5% and 5% makes it possible to obtain an effective dropping of the smears 30.

According to this particular embodiment, the moving of the support 15 by the actuators 21 is controlled automatically by the vehicle at the end of a predefined period of use thereof.

Alternatively, the actuators 21 of the support 15 can be replaced by electromagnets. In this case, the second guiding members 23 of rod type borne by the support 15 are made of a ferromagnetic material.

According to another embodiment, the actuators 21 can be mechanical systems comprising a toothed wheel and a rack for example.

The use of a piezoelectric transducer as actuator 21 makes it possible to have a fairly small and very rapid movement of the support 15 bearing the membrane 19 relative to the protection casing 13. The use of an electromagnet or of a mechanical system as actuator 21 will require a longer travel of the support 15 bearing the membrane 19 relative to the protection casing 13. The use of these second systems will allow a greater elongation of the membrane 19. For such actuators 21, an elongation of the membrane 19 lying between 5% and 15% makes it possible to obtain an effective dropping of the smears 30.

According to another embodiment, the actuator 21 can be placed outside of the protection casing 13. In this case, the actuator 21 can be located behind the protection casing 13, in front of it, or even above or below it.

According to another embodiment, the complementary first and second guiding members 22, 23 borne by the protection casing 13 and by the mobile support 15 can be systems with complementary form structure.

According to an alternative embodiment, the guiding members 23 borne by the support 15 can be of cylinder type. In this case, the complementary guiding members 22 borne by the support 15 will be of rod type. In this particular embodiment, the actuator 21 will be borne by the support 15.

According to another embodiment, it is possible to modify the times of activation of the moving of the support 15. It is for example possible to move the support 15 when the vehicle is started up.

Alternatively it is possible to command the moving of the support 15 when a detector measures a fouling state that might be detrimental to the correct operation of the optical sensor 11.

According to another embodiment, the moving of the support 15 can be commanded by the user. This is particularly advantageous when the protection device 2 is used to protect optical sensors 11 used in parking aid systems. The user can therefore activate the actuator 21, and thus allow the moving of the support 15, when he or she observes that the membrane 19 is fouled, for example when using the driving assistance system 1 as parking aid. Moreover, in this configuration, the presence of the detector is not necessary.

According to another embodiment, the membrane 19 can be directly fixed by its periphery to the plate 16 of the support 15 without requiring the use of the ring 17.

Optionally, it is possible to place a cleaning product spray nozzle in proximity to the membrane 19 so as to spray cleaning product onto the latter. The spray nozzle can be incorporated or not in the protection casing 13.

These exemplary embodiments are provided in an illustrative and nonlimiting manner. In fact, it is perfectly possible for the person skilled in the art. without departing from the scope of the invention, to replace the actuators 21 described here with any other actuator making it possible to move the support 15 by a translation substantially at right angles to the plate 16 of said support 15. Also, the person skilled in the art will be able to use any other compound exhibiting a resistance to UV and/or having hydrophobic properties and whose physical and mechanical properties are compatible with the use described above in the formulation of the elastomer forming the membrane 19 without departing from the scope of the invention. Finally, he or she will be able to replace the guiding members 22 and 23 described here with any other type of complementary guiding members without departing from the scope of the invention.

The rapid and effective cleaning, without necessarily requiring cleaning product, of the optic 4 of an optical sensor 11, possibly a camera for example, intended to equip a motor vehicle, is thus possible by virtue of the subject of the present invention which comprises an optically transparent and elastically deformable membrane 19 mounted on a mobile support 15. The support 15 cooperates with a protection casing 13 which accommodates the camera. The moving of the support 15 uses complementary first and second guiding members 22 and 23 borne respectively by the protection casing 13 and by the support 15. The support 15 is moved using one or more actuators 21, for example borne by the protection casing 13. The moving of the support 15 allows the membrane 19 to switch from its position of rest to its active position in order to allow the smears 30 to drop away.

1. A protection device protecting an optical sensor for a motor vehicle comprising:
a protection casing in which is formed a housing configured to house an optical sensor;
a support movably mounted on the protection casing and bearing a membrane fixed by its periphery to the support and arranged facing the optical sensor, the membrane comprising an optically transparent and elastically deformable material; and
at least one actuator borne by the protection casing and configured to move the support bearing the membrane;
wherein the support, under the effect of the moving of the support by the actuator, is configured to deform the membrane between a position of rest in which the membrane is in a first state of tension and an active position in which the membrane is in a second state of tension.

2. The protection device protecting an optical sensor as claimed in claim 1, wherein the optically transparent and elastically deformable material of the membrane is an elastomer.

3. The protection device protecting an optical sensor as claimed in claim 1, wherein the protection casing has:
a substantially central opening configured to allow the passage of an optic of the optical sensor; and
at least one first guiding member configured to cooperate with a complementary second guiding member borne by the support.

4. The protection device protecting an optical sensor as claimed in claim 3, wherein the support comprises a plate secured to at least one second guiding member and comprising an opening in which the membrane is placed, the plate being oriented substantially at right angles to the optical axis of the optical sensor.

5. The protection device protecting an optical sensor as claimed in claim 4, wherein the support comprises a ring for fixing the membrane surrounding the opening and in which the membrane is placed.

6. The protection device protecting an optical sensor as claimed in claim 4, wherein the complementary guiding members are oriented so as to allow a translational movement of the support along an axis substantially at right angles to the plate of the support.

7. The protection device protecting an optical sensor as claimed in claim 4, wherein the opening of the plate is configured to accommodate the optic such that the optic protrudes from the opening and is in contact with the elastic membrane.

8. The protection device protecting an optical sensor as claimed in claim 3, wherein the complementary guiding members are formed by a rod/cylinder system.

9. The protection device protecting an optical sensor as claimed in claim 1, wherein the at least one actuator of the support comprises at least one of the elements chosen from the grow consisting of: a piezoelectric transducer, an electromagnet, and a mechanical system comprising a toothed wheel and a rack.

10. The protection device protecting an optical sensor as claimed in claim 1, wherein the actuator is arranged inside the protection casing.

11. The protection device protecting an optical sensor as claimed in claim 1, wherein the actuator is arranged outside the protection casing.

12. The protection device protecting an optical sensor as claimed in claim 1, wherein the actuator is configured to move the support at a frequency lying within the ultrasound range.

13. The protection device protecting an optical sensor as claimed in claim 1, wherein the formulation of the elastomer forming the membrane exhibits properties of resistance to ultraviolet radiations and/or non-stick properties.

14. A driving assistance system comprising: an optical sensor; and the protection device as claimed in claim 1.

15. The driving assistance system as claimed in claim 14, wherein the actuator is configured to move the support along the optical axis of the optical sensor.

16. The driving assistance system as claimed in claim 15, wherein:
wherein the protection casing has:
a substantially central opening configured to allow the passage of an optic of the optical sensor; and
at least one first guiding member configured to cooperate with complementary second guiding member borne by the support,
wherein the support comprises a plate secured to at least one second guiding member and comprising an opening in which the membrane is placed, the plate being oriented substantially at right angles to the optical axis of the optical sensor, and
wherein the optic of the optical sensor protrudes through an opening of the plate of the support and is in contact with the elastic membrane arranged on the plate.
